(19) United States
(12) Patent Application Publication
(10) Pub. No.: US 2002/0192445 A1
(43) Pub. Date: Dec. 19, 2002

(54) Plastic substrate for display applications

(76) Inventors: Stephen A. Ezzell, Woodbury, MN (US); Robert S. Moshrefzadeh, Oakdale, MN (US); Elisa M. Cross, Woodbury, MN (US); Bert T. Chien, Minneapolis, MN (US); Mitsuaki Kobayashi, Tokyo (JP); Hiroshi Ayukawa, Kanagawa (JP)

Correspondence Address: Office of Intellectual Property Counsel, 3M Innovative Properties Company, P.O. Box 33427, St. Paul, MN, 55133-3427, US

(21) Appl. No.: 09/848,029

(22) Filed: May 3, 2001

(51) Int. Cl. B32B 7/02; B32B 1/00

(52) U.S. Cl. 428/212; 428/332

(57) ABSTRACT

Components for electronic displays containing a polyimide substrate and an electrical conductor are disclosed. The components are suitable for use in touch panel displays. The invention is also directed to electronic displays incorporating the components of the invention, and methods of making the display components. The combined polyimide substrate and electrical conductor are selected such that they have high internal radiation transmissivity, and typically have an effective radiation absorption coefficient of less than 0.02 per micron at wavelengths from 400 to 450 nm. In addition, the polyimide substrate permits processing of the display components at elevated temperatures, and usually has a glass transition temperature greater than 300° C.

The present invention is directed to electronic display components, including touch panel display components for use in electronic devices. The invention is also directed to touch panel and non-touch panel electronic displays.

### BACKGROUND

Liquid crystal display (LCD) devices and other electronic display technologies have gained widespread use in recent years as a result of the increasing popularity of notebook computers, personal digital assistants, wireless telephones, and other electronic devices. Some of these display technologies incorporate touch sensitive components that permit the display to function as a data input device.

LCDs and other electronic displays, particularly those with touch sensitive components, should often be constructed to withstand rigorous environmental conditions while maintaining a quality display image, thin profile, and low weight. Durability and weight can be critical when the displays are to be used in portable devices, such as mobile phones and personal digital assistants. The components in these displays should be able to withstand significant physical abuse, and therefore should not be fragile. Also, the components should be able to withstand elevated temperatures, as well as temperature fluctuations, because they are typically exposed to a wide range of different temperatures during manufacturing and use.

In addition to being rugged, displays should provide a high quality image, which depends in part on the clarity of the components used in the display. Clarity is particularly important in LCD displays, which function as an array of light gates that selectively allow the passage of light to form an image. If the visible LCD display components are not transparent or substantially transparent to most visible light, then the display can be dim, energy inefficient, and off-color.

Therefore, a need exists for display components that are rugged, able to withstand elevated temperatures, and are substantially transparent to visible light.

### SUMMARY OF THE INVENTION

The present invention is directed to components for electronic displays, including touch panel displays. The invention is also directed to electronic displays incorporating the display components of the invention, and to methods of making electronic displays and display components. The invention allows formation of a substantially clear, flexible substrate on which is placed a transparent conductive layer having favorable conductive properties. The present invention permits formation of rugged display components that have low absorbance of light, particularly of blue light in the visible spectrum, while still having favorable conductivity properties.

The flexible substrate allows a variety of additional components to be adhered to it without significant degradation of the substrate or the adhered component. In particular, the flexible substrate permits annealing of a transparent conductor (such as indium tin oxide) on the substrate at elevated temperatures without degradation of the substrate. In this manner desired conductivity can be achieved using thinner transparent conductors that exhibit higher transmissivity, all on a clear plastic substrate. As such, the invention permits displays, display components, and display related devices to be formed that accurately reproduce color while maintaining the durability of using a flexible substrate. The flexible substrate can also be bonded or adhered to other display related substrates, including glass substrates.

The display components of the invention contain a polyimide substrate and an electrical conductor. The electrical conductor is normally permanently bonded to the substrate in order to form a single composite structure containing the polyimide substrate plus the electrical conductor. The combined polyimide substrate and electrical conductor are usually formed in a manner such that they are substantially clear, allowing a high-quality image to be displayed. In certain embodiments the substrate and conductor have a combined effective radiation absorption coefficient of less than 0.02 per micron at wavelengths from 400 to 450 nm, and an average internal radiation transmissivity greater than 90 percent at wavelengths from 400 to 700 nm for a 25 micron thick polyimide substrate.

In addition to being highly transparent, the polyimide substrate usually has a glass transition temperature high enough to permit processing of the display components at elevated temperatures. Typical glass transition temperatures of polyimide substrates made in accordance with the invention are greater than 300° C., which allows the substrate and conductor to be annealed together at elevated temperatures without excessive deterioration of the substrate. In addition, this high glass transition temperature allows other processing techniques that require elevated temperatures, such as the formation of precision alignment layers for liquid crystal displays.

Various electrical conductors can be used in the display components of the invention, including indium tin oxide or conductive polymers. The electrical conductor is usually substantially transparent at the thickness used in display components, and typically has a radiation transmissivity of greater than 30 percent at wavelengths from 400 to 700 nm for a 25 micron thick sample. When the conductor is used in a touch panel display, it normally has a sheet resistance of less than 5000 ohm per square.

The polymeric substrate and conductive layer can be a separate, independent display component. Alternatively, the polymeric substrate can be integrally formed (e.g., coated, laminated, or bonded) on top of another material, such as a glass sheet, for example to reinforce a very thin glass sheet without significantly impacting its clarity. The polyimide substrate and conductive layer can be produced to cover a range of sizes and thicknesses. Normally the polyimide substrate is less than 1.5 mm thick, while the electrical conductor usually has a thickness from 0.01 to 10 microns.

Other aspects of the invention will be described in the detailed description and claims.

### BRIEF DESCRIPTION OF THE DRAWINGS

FIG. 1A is a partial cross-sectional diagram of a display component constructed and arranged in accordance with the invention.

FIG. 1B is a partial cross-sectional diagram of a resistive touch panel constructed and arranged in accordance with the invention.

FIG. 1C is a partial cross-sectional diagram of a display incorporating a touch panel constructed and arranged in accordance with the invention.

While principles of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION OF THE INVENTION

The present invention is directed to components for electronic displays, including touch panel displays. The invention is also directed to electronic displays incorporating the components of the invention, and methods of making electronic displays and display components. Specific aspects of the invention include touch panel displays containing a polyimide substrate and an electrical conductor. The combined polyimide substrate and electrical conductor are usually selected such that they are substantially clear, thus allowing a high-quality image to be displayed. The polyimide substrate of the invention permits an improvement in the optical performance of electronic displays, and enables integration of the electronic components of the display. Also, the polyimide substrate has a sufficiently high glass transition temperature that it is suitable for high temperature processing, such as to anneal electrical conductors, attach electrical leads, or form precision alignment layers.

Specific implementations of the invention are directed to a touch component for use in an electronic display, the component including a polyimide substrate wherein the polyimide substrate has a radiation absorption coefficient of less than 0.02 per micron at wavelengths from 400 to 450 nm. The polyimide substrate and electrical conductor can have an average internal radiation transmissivity greater than 90 percent at wavelengths from 400 to 450 nm for a 25 micron thick substrate for certain embodiments, and an internal radiation transmissivity greater than 90 percent at wavelengths from 400 to 700 nm in other embodiments.

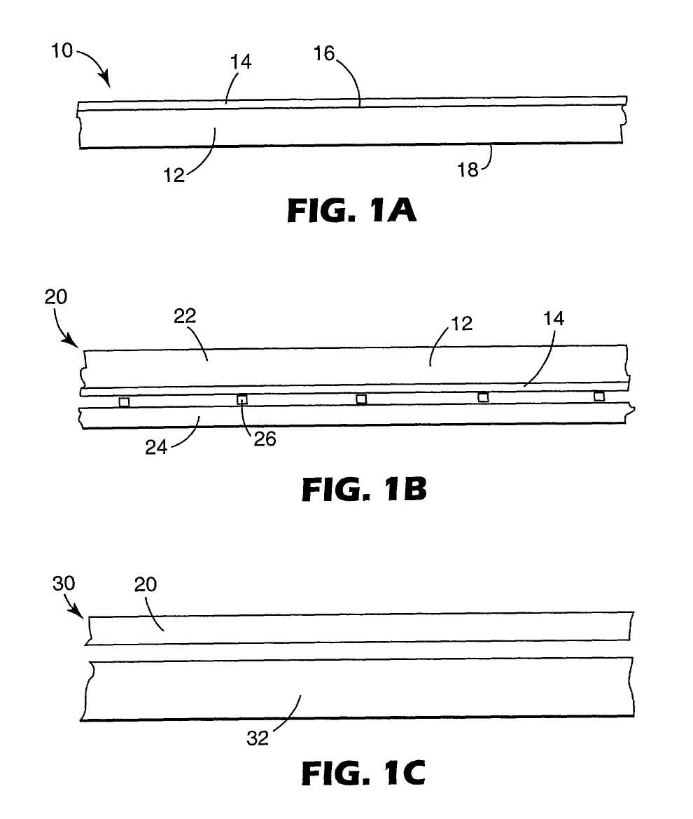

In reference now to the drawings, FIG. 1A shows a partial cross section of an example composite structure 10 having a polyimide substrate 12 and an electrical conductive layer 14. In the embodiment shown, the electrical conductive layer 14 is indium tin oxide, which is a conductive oxide having relatively high radiation transmissivity. The substrate 12 and conductive layer 14 are shown joined along their interface 16. A bond is created at the interface by forming the polyimide substrate, applying a conductive oxide to the substrate, and then annealing the substrate and oxide together at elevated temperatures. In the embodiment shown in FIG. 1A the conductive layer 14 covers the entire surface of the polyimide substrate 12. In other implementations (not shown) the conductive layer is applied in a patterned manner such that only portions of the polyimide substrate 12 are covered. For example, the conductive layer can be coated and then subsequently etched, can be selectively deposited using a mesh, and so forth. In other implementations the conductive layer is physically non-uniform but electrically continuous.

Although only two components are shown in composite structure 10 in FIG. 1A, additional components can be included. For example, one or more additional layers can be added to the top surface 16 of the conductive layer 14 or the bottom surface 18 of the polyimide substrate 12. Additional layers are not typically added between the polyimide substrate 12 and the conductive layer 14, although such layers may be included in specific embodiments. For example, in specific implementations the polyimide is present on both sides of the electrical conductor. Such implementations are useful when it is desirable to insulate the electrical conductor or to provide a protective layer for the electrical conductor. Capacitive touch panel displayers are one appropriate use for these implementations.

In certain implementations, the invention structure 10 of FIG. 1A is used in a touch panel, such as that disclosed in FIG. 1B. Example touch panel 20 includes two transparent conductive sheets 22, 24 separated by spacers 26. The top conductive sheet 22 is constructed of the polyimide substrate 12 and conductive layer 14 (reversed relative to the depiction in FIG. 1A). By pressing on the exposed surface of the polymeric substrate 12 (directly or through an intermediate layer or layers), the conductive layer 14 can be brought into local contact with the lower conductive sheet 24, which can be single or multi-layer, to form a temporary circuit that is used to locate the point of contact by resistive or capacitive methods. Touch panel 20 of FIG. 1B can be incorporated into a display, such as that shown in FIG. 1C. Display 30 includes the touch panel 20 overlaying display components 32. Display components 32 include, for example, an LCD, cathode ray tube, plasma display, or organic electroluminescent display. Display 30 is depicted with a resistive touch panel, however other types of touch panels can also be used.

Various aspects of the display components of the invention, their uses and production, will now be discussed in greater detail.

### A. Polyimide Substrate

Polyimide substrates of the invention exhibit advantageous optical properties and certain processing advantages based upon the three-dimensional structure of the polymer from which they are formed. Physical and optical properties of the films can be tailored by appropriate selection of monomers, and it may be desirable to strike a balance between them. The substrates typically appear to be essentially colorless to the naked eye.

The polyimides have a sufficiently high glass transition temperature that they can be heated to temperatures high enough to anneal transparent conductive oxides without excessive degradation of the polyimide substrate. Typically such polyimides have a glass transition temperature exceeding 300° C. The glass transition temperature is commonly in the range of 310 to 380° C.

Various polyimide compositions can be used to form the substrate of the present invention. These polyimides include those disclosed in U.S. Pat. No. 5,750,641, incorporated herein by reference in its entirety. Although a variety of polyimides are suitable for use with the invention, the polyimide normally contains pendant fluorene groups. The pendant fluorene groups have the general formula:

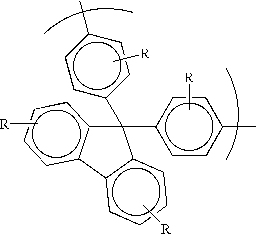

wherein R is from 0 to 4 substituents selected from the group consisting of hydrogen, halogen, phenyl, phenyl group substituted by 1 to 4 halogen atoms or alkyl groups having 1 to 10 carbon atoms, and an alkyl group having from 1 to 10 carbon atoms.

The polyimide substrate normally comprises the copolymerization product of a 9,9-bis(ortho-substituted aminoaryl)fluorene compound wherein the ortho-substituted groups are selected from the group consisting of halogen, phenyl group, and an alkyl group having from 1 to 10 carbon atoms, at least one aromatic tetracarboxylic acid dianhydride, and an aromatic diamine free of fused rings.

Generally, polyimides of the invention have a plurality of fluorene groups attached orthogonally to the polymer backbone. This orthogonal arrangement provides large, polarizable sites for interaction with solvents. The steric bulk and geometry of the fluorene component disrupts chain packing, which enhances the ability of solvents to interact with the polymer chain. This steric effect also disrupts the formation of charge-transfer complexes, resulting in colorless or light yellow materials.

The polyimide can contain index matched glass particles to control thermal expansion. In certain embodiments the polyimide can be made diffusive, such as by adding particles to the polyimide solution when the index of refraction of the particles is different than that of the polyimide. The amount of diffusion can be controlled by adjusting, for example, the particle index, particle loading, and coating techniques. Colorants can be added to give desired color. Also, the appearance can be made diffusive by imparting surface texture to the polyimide.

### B. Electrical Conductor

The display components of the invention typically include an electrical conductor. Various electrical conductors are suitable for use with the invention, but in most implementations the electrical conductor is transparent or substantially transparent to visible light at the thickness that they are applied to the polyimide substrate.

Of particular usefulness are transparent conductive oxides, including indium tin oxide, zinc oxide, antimony tin oxide, aluminum zinc oxide, indium zinc oxide, boron zinc oxide, and titanium oxide. These transparent conductive oxides can be used singly or in combinations to provide desired electrical conductive and light transmissive properties. The conductor can also be a conductive anti-reflective coating.

The electrical conductor can be annealed to the polyimide substrate at an elevated temperature to improve its optical or conductive properties. Such annealing improves the conductive properties of transparent conductive oxides, which allows application of a thinner conductive layer without diminishing conductive properties. Using a thinner conductive layer while maintaining conductive properties is normally advantageous because it reduces light absorption by the conductive layer. Annealing can also improve optical transmission of the conductor in specific embodiments. Annealing is normally performed by exposing the electrical conductor to temperatures greater than 200° C. for 30 minutes or more. The polyimide substrate should normally be selected to withstand these elevated temperatures when annealing processes are to be performed.

The conductivity of the electric conductor can be selected depending upon the intended use by varying its thickness, as well as by annealing the conductor. When used in a touch panel display the electrical conductor should usually have intermediate conductivity that allows flow of electrons but limits the flow sufficiently to make differential current flow across the substrate surface measurable (this differential flow is used to determine the location of the touch on the touch panel). In most implementations the conductor has a sheet resistance of less than 5000 ohm per square. Even more commonly, this sheet resistance is less than 2000 ohm per square, but greater than 10 ohms per square.

The combined polyimide substrate and annealed conductive layer allow for a relatively thin conductive layer. Specific implementations of the invention use an indium tin oxide (ITO) conductive layer on the polyimides substrate. Generally, such ITO layers are from 0.01 to 10 microns thick, more commonly from 0.05 to 5 microns. ITO layers are normally less than 5 microns, and more typically less than 1 micron thick.

### C. Composite Display Components and Displays

The composite display component of the invention contains a polyimide substrate and electrical conductor to provide a lightweight, durable, and highly transparent display component suitable for touch panels and other displays. Although the component is typically highly transparent, the transparency can be adjusted depending upon the specific application.

The total transmission of the polyimide substrate can be directly measured by comparing the intensity of radiation applied to the substrate compared to the amount of radiation that passes through the substrate. This total transmission value gives the percentage of light that passes through the substrate. Most light that is not transmitted is either absorbed by the substrate or is reflected at one of the substrate surfaces (either entering the substrate or leaving the substrate).

Polyimide substrates produced in accordance with the invention typically have a relatively high transmissivity of short wavelength visible light, as opposed to poorer transmission in the blue region of the visible spectrum that gives many conventional polyimides their yellowish appearance. The polyimide can have an average internal radiation transmissivity greater than 80 percent for a 25 micron thick substrate, and even more typically greater than 90 percent for a 25 micron thick substrate, at radiation wavelengths from 400 to 450 nm. Specific implementations include an average internal radiation transmissivity greater than 95 percent for a 25 micron thick substrate. The substrates typically have an average internal radiation transmissivity of greater than 80 percent for a 25 micron thick substrate, and even more typically greater than 90 percent for a 25 micron thick substrate at radiation wavelengths from 400 to 500 nm.

The polyimide substrates of the invention also provide high transmissivity at longer wavelengths of visible light, and transmissivity is usually higher at longer wavelengths than at shorter wavelengths. The substrates typically have an average internal radiation transmissivity of greater than 90 percent for a 25 micron thick substrate, and even more typically greater than 95 percent for a 25 micron thick substrate, at radiation wavelengths from 500 to 600 nm. The substrates typically have an average internal radiation transmissivity of greater than 95 percent for a 25 micron thick substrate, at radiation wavelengths from 600 to 700 nm. The substrates typically have an average internal radiation transmissivity of greater than 95 percent for a 25 micron thick substrate from 400 to 700 nm. The substrate can include suitable colorants to produce a desired spectrum of light that passes through the substrate.

The transparency of the composite structure (as well as individual components) can also be expressed in terms of the following equation:

T=Ke^{-αd}

where “T” is transmission, “K” is a transmission constant, “α” is the absorption coefficient, and “d” is the thickness of the film. Transmission T can have ranges from zero for a completely opaque material (where α approaches infinity) to a theoretical maximum of k (thus, where e^{-αd} equals 1, and α equals 0. As used herein transmission T is multiplied by 100 to give a transmission percent.

Absorption coefficient α can be empirically determined for a material at specific wavelengths by measuring the percentage transmission of radiation over a range of thicknesses d, and then fitting this data to a graph to determine α.

Using this methodology, the transmissivity was measured for three samples of polyimide constructued in accordance with the present invention, having a thickness of 1.0, 3.0 and 7.0 mils (about 26, 78, and 182 microns, respectively).

TABLE 1

| | Average Wavelength | |
|---|---|---|
| Thickness (mil) | (nm) | Transmission (%) |
| 1 | 400-500 | 87.2 |
| 3 | 400-500 | 85.0 |
| 7 | 400-500 | 82.5 |
| 1 | 500-600 | 89.5 |
| 3 | 500-600 | 88.8 |
| 7 | 500-600 | 84.0 |
| 1 | 600-700 | 90.0 |
| 3 | 600-700 | 89.5 |
| 7 | 600-700 | 89.5 |

The polyimide substrate of the samples in Table 1 had an absorption coefficient of approximately 0.01 per mil (about 0.39 per mm, or 0.00039 per micron) for wavelengths from 400 to 500 nm, 0.002 per mil (0.079 per mm) for wavelengths from 500 to 600 nm, and 0.0001 per mil (0.0039 per mm) for wavelengths from 600 to 700 nm. The polyimide substrate of the invention typically has an average absorption coefficient of less than 0.3 per mil (11.8 per mm, or 0.0118 per micron) for wavelengths from 400 to 450 nm, more typically less than 0.1 per mil (3.9 per mm) for wavelengths from 400 to 450 nm, and even more typically from 0.001 to 0.005 per mil (0.039 to 0.197 per mm) over these wavelengths. The polyimide substrate of the invention typically has an average absorption coefficient of less than 0.01 per mil (0.39 per mm) for wavelengths from 400 to 500 nm, more typically less than 0.005 per mil (0.197 per mm) for wavelengths from 400 to 500 nm, and even more typically from 0.001 to 0.005 per mil (0.039 to 0.197 per mm) over these wavelengths. The polyimide substrate of the invention typically has an average absorption coefficient of less than 0.01 per mil (0.39 per mm) for wavelengths from 400 to 700 nm, and more typically less than 0.005 per mil (0.19 7 per mm) for wavelengths from 400 to 700 nm.

The effective radiation absorption coefficient can be determined by applying the same formula to transmissivity measurements made for the combined substrate and electrical conductor, in which “d” equals the combined thickness of the layers. Typically the thickness is predominantly made up by the polyimide and the thickness of the conductor can be disregarded for approximate measurements. The absorbance of the conductor cannot normally be disregarded because the conductor frequently has relatively low transmissivity of light at visible wavelengths.

The combined polyimide substrate and electrical conductor can have an effective radiation absorption coefficient of less than 0.2 per mil (7.87 per mm) at wavelengths from 400 to 450 nm. The substrate and conductor usually have an effective radiation absorption coefficient of less than 0.3 per mil (11.81 per mm) at wavelengths from 400 to 450 nm; and an effective radiation absorption coefficient of less than 0.5 per mil (19.7 per mm) at wavelengths from 400 to 500 nm.

The thickness of the polyimide substrate and conductive layer normally depends upon the application for which the composite structure will be used. Thus, some applications permit or require a thicker structure while others permit or require a thinner structure. For example, when used as the top layer in a touch panel display, the composite structure should be sufficiently thin to permit deflection by a finger or other pointing devices. In these implementations the combined thickness is typically less than 500 microns, more typically less than 250 microns. The polyimide substrate is usually considerably thicker than the conductive layer. Specific suitable ranges of thickness for the polyimide substrate include substrates less than 2.5 mm, less than 1.5 mm, and less than 0.75 mm. The electrical conductor is typically less than 10 microns thick, and normally greater than 0.01 microns thick.

In addition to the conductive layer, various other layers can be added to the polyimide substrate. For example, gas and moisture barrier layers may be applied. Such layers can include silicon oxides or other similar non-reactive materials. Alternatively, color filters, reflective and non-reflective coatings, polarizers, retarders, and alignment layers for liquid crystals can all be incorporated into the polyimide substrate and electrical conductors in order to provide enhanced performance or functionality, including use as a substrate for thin film transistors. Finally, in specific implementations the polyimide is applied to thin glass sheets to provide enhanced durability for the glass sheets while maintaining a high radiation transmissivity and the ability to process the glass sheet at high temperatures. This can allow for the use of much thinner glass when glass is preferred as a substrate, thereby reducing the amount of weight and space taken up by the substrate while getting other desired benefits of glass, such as hardness and transparency.

The polyimide substrate and electrical conductor of the invention are particularly well suited for use in touch panels that allow a user to input information or access information with a simple touch of a finger or stylus to a display. The touch panels can include, for example, LCDs, cathode ray tubes (CRTs), and plasma displays. The display components of the invention are suitable for either resistive or capacitive touch panels. The displays may be reflective or transmissive; and portable, desktop, handheld, etc.

### D. Production Methods

The polyimide can be produced using various production methods. For example, a solution of the polyimide can be cast into a film or it can be coated upon a suitable substrate. When used as a substrate in a liquid crystal display the polyimide can be coated on one or both sides of a liquid crystal cell. Alternatively, the polyimide can be coated on a stretched biaxially oriented polymer film such as polycarbonate, polystyrene, polyester, or poly(methylmethacrylate).

In one embodiment, a polyimide substrate of the invention is prepared by coating from solvent a polymer comprising the condensation polymerization product of a 9,9-bis(ortho-substituted aminoaryl)fluorene with an aromatic tetracarboxylic acid dianhydride, the polymer having one or more repeating units corresponding to the formula:

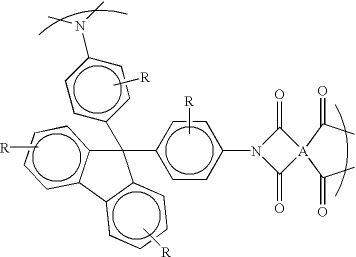

wherein each R is from 0 to 4 substituents selected from the group consisting of hydrogen, halogen, phenyl, phenyl group substituted by 1 to 4 halogen atoms or alkyl groups having 1 to 10 carbon atoms, and an alkyl group having from 1 to 10 carbon atoms; and A is a tetra-substituted aromatic moiety. After formation of the substrate a conductive layer, such as indium tin oxide, is applied. The conductive layer is annealed to the substrate by heating to at least 200° C. for 30 minutes in air.

### E. EXAMPLES

The following examples were prepared in order to demonstrate properties of the invention. In Example 1 a polyimide substrate was prepared in accordance with the present invention. In Example 2, a known polyimide composition was prepared for comparative purposes with the substrate from Example 1. In Example 3, the improved conductivity properties are demonstrated of a substrate containing an indium tin oxide conductive layer after being annealed at 200° C.

### Example 1

A polyimide powder was prepared using the following procedure: A 100-ml three-necked flask was placed under a nitrogen atmosphere and equipped with an overhead stirrer. The flask was charged with 0.34 g of DMPDA, 0.94 g of OTBAF and 2.22 g of 6FDA. Next, the flask was charged with 25 mL of DMAC. Initially, the reaction temperature was kept at room temperature with a water bath. The solution viscosity increased as the reaction was stirred overnight at room temperature. Next, the reaction was charged with 2.0 mL of acetic anhydride and 1.8 mL of pyridine. The mixture was heated at 105-110° C. for two hours and cooled to room temperature. The polymer was coagulated with methanol in a blender and then filtered. The white solid thus obtained was resuspended in methanol, filtered, and dried under vacuum (30 mm Hg) at 50° C. to yield 2.8 g of a white powder. (Tg=367° C.; Mn=7.6×10⁴; Mw=5.34×10⁵.) The polyimide powder was dissolved in N-methyl-2-pyrrolidone (NMP), making an approximately 10 wt % solids solution of polyimide in NMP. To produce dry films with different thickness values, different volumes of this solution were cast into identical, carefully leveled, flat-bottomed glass dishes at room temperature. The solution in each glass dish was allowed to carefully flow to produce a level and uniform wet thickness in the dish. The solution was very slowly dried under low flow of nitrogen to form a film, which was dried until it felt dry to touch. The films were further dried in an oven with nitrogen flow until solvent was effectively completely removed. Three such films were made having thickness values of 0.8, 3, and 7.1 mils (about 20, 75, and 180 microns, respectively).

The index of refraction of these films was measured at the following four different wavelengths: 488, 568, 633, and 700 nm. The results were:

n(488)=1.6091

n(568)=1.5943

n(633)=1.5865

n(700)=1.5807

These indices were fitted to n=A+B/λ² using a least square fit. The result was: n=1.5537+13171.5/λ².

To determine the absorption coefficient of this polyimide, total transmission of the three samples was measured from 400-700 nm. The transmission was averaged in the following three different wavelength ranges: 400-500 nm referred to as the blue region, 501-600 nm referred to as the red region, and 601-700 nm referred to as the red region. For each wavelength region the average transmission values were fitted to an exponential of the form:

T=Ke^{-αd}

Where T is transmission, α is the absorption coefficient, d is film thickness, and k is a constant determined when fitting the data to the above equation using a least square fit.

The calculated absorption coefficients in the three wavelength regions are given in Table 2:

TABLE 2

| | | | |
|---|---|---|---|
| Wavelength Region (nm): | 400-500 | 501-600 | 601-700 |
| Absorption coefficient (mil⁻¹): | 0.01 | 0.002 | 0.001 |

Thus, the absorption coefficient of this example polyimide is quite low even in the blue region. As an example, the internal transmission of a 2 mil thick Polyimide film is 98% in the blue region. For a 5 mil thick film the internal transmission is 95%.

### Example 2

To compare the transparency of the substrate from Example 1 with those disclosed in Japanese patent number Kokai 1-165623, a sample was prepared as described in Kokai 1-165623 in example 4, which claims a transmission of 91% for a 25 micron (1 mil) thick film. Six films with different thickness were made using the methods used in Example 1: 0.15, 0.76, 0.96, 1.04, 1.35, and 1.92 mils. Absorption coefficients in blue, green, and red regions of the spectrum were calculated using the same methodology from Example 1, and are given below in Table 3:

TABLE 3

| | | | |
|---|---|---|---|
| Wavelength Region (nm): | 400-500 | 501-600 | 601-700 |
| Absorption coefficient (mil⁻¹): | 0.28 | 0.03 | 0.01 |

Therefore for a 1 mil thick film the internal transmission is 75% in the blue region, 97% in the green region, and 99% in the red region resulting in an average transmission of 90.3% in the visible region, which is very close to the reported 91%. However, the blue transmission is quite low. In contrast for a 1 mil thick film of a substrate described in Example 1, the internal transmission is 99% in the blue region, 99.8% in the green region, and 99.9% in the red region resulting in an average transmission of 99.6% in the visible region.

### Example 3

A polyimide film according to the present invention was sputter coated with indium tin oxide (ITO) resulting in a sheet resistance of 40 Ohms/Square. Subsequently, the ITO coated polyimide was annealed at 200° C. for about 30 minutes. The sheet resistance dropped to 30 Ohms/Square. This example demonstrates that annealing of an ITO coating can be achieved at high temperatures resulting in more conductive ITO.

The above specification and examples are believed to provide a complete description of the manufacture and use of particular embodiments of the invention. Many embodiments of the invention can be made without departing from the spirit and scope of the invention.

We claim:

1. A touch panel, the touch panel comprising:
a polyimide substrate; and
an electrical conductor;
wherein the combined polyimide substrate and electrical conductor have an effective radiation absorption coefficient of less than 0.02 per micron at wavelengths from 400 to 450 nm.

2. The touch panel of claim 1, wherein the polyimide substrate has a glass transition temperature greater than 300° C.

3. The touch panel of claim 1, wherein the polyimide substrate has a radiation absorption coefficient of less than 0.3 per mil at wavelengths from 400 to 450 nm.

4. The touch panel of claim 1, wherein the combined polyimide substrate and electrical conductor have an average internal radiation transmissivity greater than 90 percent at wavelengths from 400 to 700 nm for a 25 micron thick substrate.

5. The touch panel of claim 1, wherein the polyimide substrate has an average internal radiation transmissivity greater than 95 percent at wavelengths from 400 to 700 nm for a 25 micron thick substrate.

6. The touch panel of claim 1, wherein the combined polyimide substrate and electrical conductor have an average internal radiation transmissivity greater than 90 percent at wavelengths from 400 to 450 nm for a 25 micron thick substrate.

7. The touch panel of claim 1, wherein the combined polyimide substrate and electrical conductor have an average internal radiation transmissivity greater than 90 percent at wavelengths from 400 to 500 nm for a 25 micron thick substrate.

8. The touch panel of claim 1, wherein the combined polyimide substrate and electrical conductor have an effective radiation absorption coefficient of less than 0.2 per mil at wavelengths from 400 to 450 nm.

9. The touch panel of claim 1, wherein the combined polyimide substrate and electrical conductor have an effective radiation absorption coefficient of less than 0.5 per mil at wavelengths from 400 to 500 nm.

10. The touch panel of claim 1, wherein the electrical conductor is substantially transparent.

11. The touch panel of claim 10, wherein the electrical conductor comprises a conductive polymer.

12. The touch panel of claim 11, wherein the electrical conductor comprises tin oxide.

13. The touch panel of claim 12, wherein the tin oxide comprises indium tin oxide.

14. The touch panel of claim 1, wherein the polyimide substrate has a thickness of less than 1.5 mm.

15. The touch panel of claim 1, wherein the electrical conductor has a thickness from 0.01 to 10 microns.

16. The touch panel of claim 1, wherein the electrical conductor has a conductivity of less than 5000 ohm per square.

17. The touch panel of claim 16, wherein the electrical conductor has a conductivity of less than 2000 ohm per square.

18. The touch panel of claim 1, wherein the polyimide comprises pendant fluorene groups.

19. The touch panel of claim 18, wherein the pendant fluorene groups have the general formula: 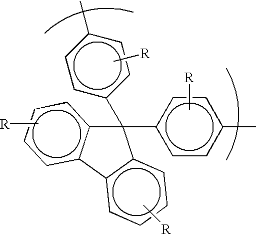
wherein R is from 0 to 4 substituents selected from the group consisting of hydrogen, halogen, phenyl, phenyl group substituted by 1 to 4 halogen atoms or alkyl groups having 1 to 10 carbon atoms, and an alkyl group having from 1 to 10 carbon atoms.

20. The touch panel of claim 1, wherein the polyimide substrate comprises the copolymerization product of a 9,9-bis(ortho-substituted aminoaryl) fluorene compound wherein the ortho-substituted groups are selected from the group consisting of halogen, phenyl group, and an alkyl group having from 1 to 10 carbon atoms, at least one aromatic tetracarboxylic acid dianhydride, and an aromatic diamine free of fused rings.

21. The touch panel of claim 1, wherein the touch panel is configured for use in a display.

22. A display for use in an electrical device, the display comprising:
a polyimide substrate having a glass transition temperature greater than 300° C.; and
a transparent electrical conductor;
wherein the combined polyimide substrate and electrical conductor have an effective radiation absorption coefficient of less than 0.4 mil at wavelengths from 400 to 450 nm.

23. The display of claim 22, wherein the combined polyimide substrate and electrical conductor have an average internal radiation transmissivity greater than 90 percent at wavelengths from 400 to 450 nm for a 25 micron thick substrate.

24. The display of claim 22, wherein the polyimide substrate has an average internal radiation transmissivity greater than 95 percent at wavelengths from 400 to 450 nm for a 25 micron thick substrate.

25. The display of claim 22, wherein the electrical conductor is substantially transparent.

26. A process for forming a display component for use in an electronic display, the process comprising:
providing a polyimide substrate; and
applying a transparent electrical conductor to the polyimide substrate;
wherein the combined polyimide substrate and electrical conductor have an effective radiation absorption coefficient of less than 0.02 per micron at wavelengths from 400 to 450 nm.

27. The process for forming a display component according to claim 26, further comprising heating the polyimide substrate and electrical conductor to a temperature greater than 150° C.

28. The process for forming a display component according to claim 26, wherein the combined polyimide substrate and electrical conductor have an internal radiation transmissivity greater than 90 percent at wavelengths from 400 to 450 nm for a 25 micron thick substrate.

29. The process for forming a display component according to claim 26, wherein the polyimide substrate has an internal radiation transmissivity greater than 90 percent at wavelengths from 400 to 700 nm for a 25 micron thick substrate.
